(19) United States
(12) Patent Application Publication
(10) Pub. No.: US 2014/0043359 A1
(43) Pub. Date: Feb. 13, 2014

(54) METHOD, APPARATUS, AND SYSTEM FOR IMPROVING AUGMENTED REALITY (AR) IMAGE TARGETS

(71) Applicant: Peter Andic, Cambridge (GB)

(72) Inventor: Peter Andic, Cambridge (GB)

(73) Assignee: QUALCOMM Incorporated, San Diego, CA (US)

(21) Appl. No.: 13/569,817

(22) Filed: Aug. 8, 2012

(51) Int. Cl. G06T 1/00

(52) U.S. Cl. 345/619

(57) ABSTRACT

Apparatus, systems and methods for improving augmented reality (AR) targets are disclosed. A method described herein for improving augmented reality (AR) targets includes modifying an AR target with a client's software, sending a request for feedback on the AR target to a server, receiving feedback from the server, displaying, by the client's software, the feedback over the AR target and saving, by the client's software, the AR target to memory.

### BACKGROUND

I. Field of the Invention

This disclosure relates generally to systems, apparatus and methods for producing AR (augmented reality) targets, and more particularly to providing real-time feedback to a creator of AR targets.

II. Background

AR applications often use a target, which includes an image, video or a combination of both, to determine a relative orientation and distance between the target and a user's equipment (e.g., camera). Based on a determined orientation and distance, a processor coupled to the user's camera may render and insert computer generated graphics having a proper orientation and size with respect to the current orientation of and distance to the target. The processor determines this orientation and distance based on features or key points in the target image itself. A good AR target includes a well distributed and unique set of features randomly located in the AR target.

When a user or an artist (such as a graphic artist or designer) creates an AR target, the artist is often unsure whether the target qualifies as a good target for AR purposes. Often several iterations are needed where the artist modifies the target in a first package and uses a separate second package to manually send the target as a request to a server. The server receives the request for a rating and the feature points of the target. Within the second package, the artist retrieves the resulting rating and feature points from the server and observes the quality of detected feature points. The artist may then return to the first package to adjust the image in an effort to increase the quality of the feature points. Using this time consuming process and multiple-package approach, the artist may create several versions of the target, which can occupy excessive hard drive memory. In some cases, the artist may be discouraged from spending additional time to optimize the target and may ultimately select a suboptimal or an incorrect version of the several versions saved to the hard drive to send to the server or treat as the final desired AR target. As a result, the artist may settle on a suboptimal or an incorrect target for an AR program.

What is needed is a single application with a user interface to generate potential targets for an AR program and to receive and overlay feedback for the artist.

### BRIEF SUMMARY

Disclosed are apparatus, systems and methods for improving augmented reality (AR) images. According to some aspects, disclosed is a method in a client device for improving augmented reality (AR) targets, the method comprising: modifying an AR target with the client's software; sending a request for feedback on the AR target to a server; receiving feedback from the server; and saving, by the client's software, the AR target to memory.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows an AR image.

FIG. 2 illustrates a process flow, in accordance with some embodiments of the present invention.

FIG. 3A shows a client having a first application for editing AR images and a second application for requesting feedback from a server.

FIG. 3B shows a client running client's software having a user plug-in module, in accordance with some embodiments of the present invention.

FIG. 4 shows a display image including a plurality of feature points, in accordance with some embodiments of the present invention.

FIG. 5 shows an example of a rating system.

FIG. 6 shows a flow chart in accordance with some embodiments of the present invention.

FIG. 7 illustrates a flow chart for improving AR targets.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

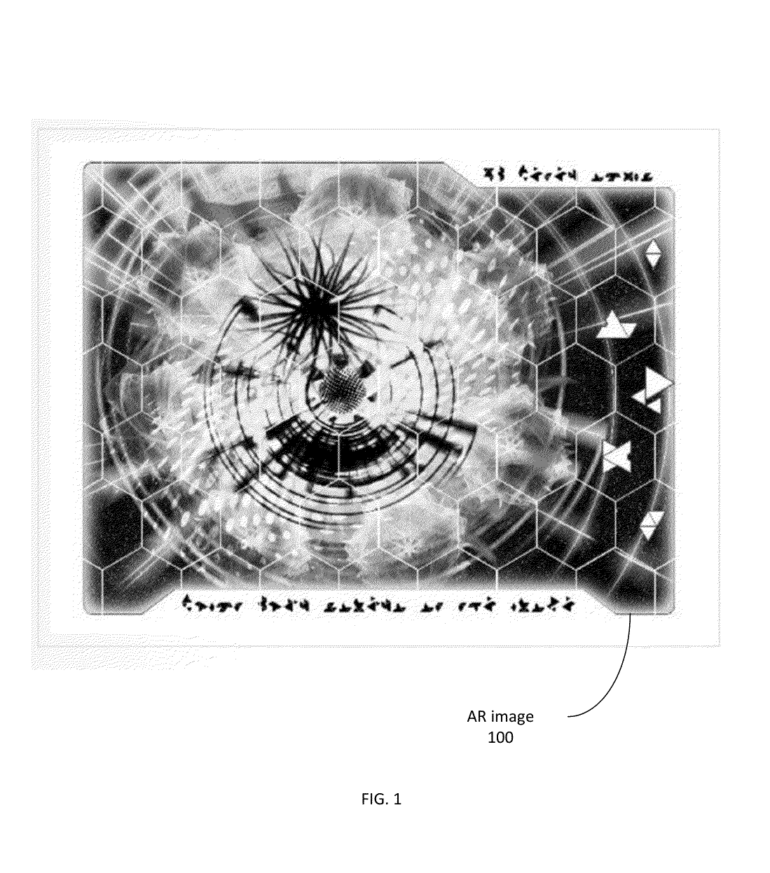

FIG. 1 shows an AR image 100. The AR image may be entirely created from graphics, may be a natural picture or video, or may be a combination of both created and natural works. The AR image 100 may begin as an image with poor or suboptimal AR qualities. Through repeated user iterations, the AR image may develop into a good AR target image. A good AR target includes a well distributed and unique set of features randomly located in the AR target.

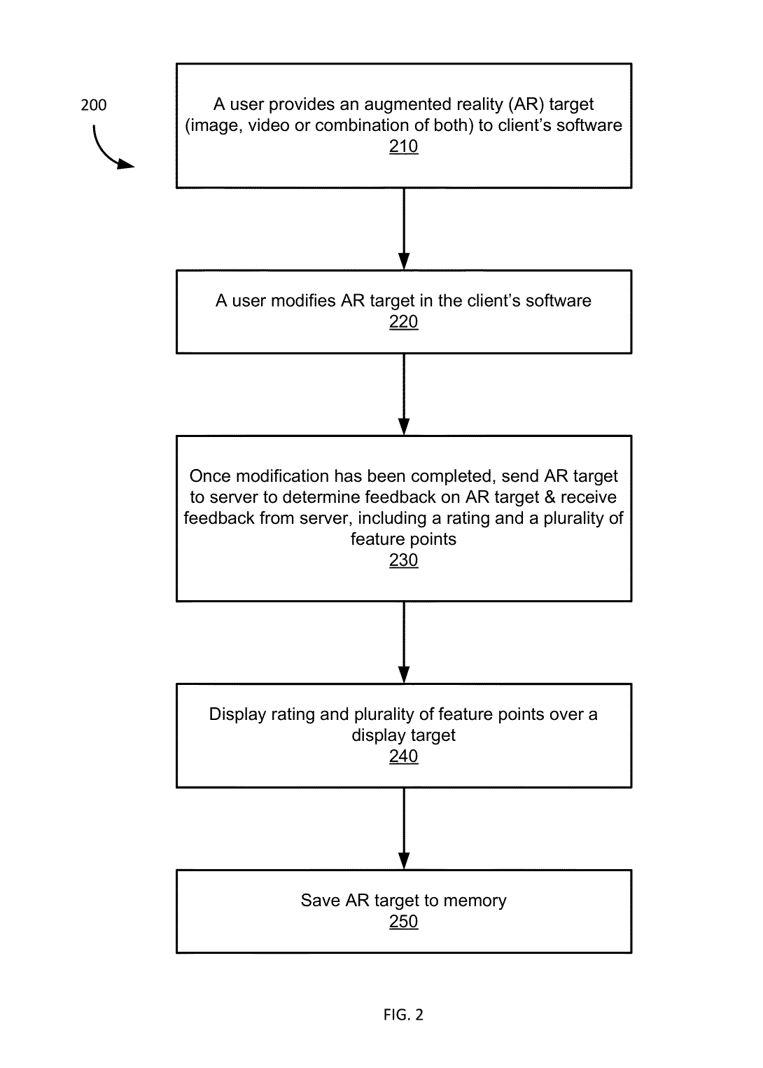

FIG. 2 illustrates a process flow 200, in accordance with some embodiments of the present invention. The client's software (e.g., Adobe Photoshop® or other photo/video editing software) resides on a client device, such as a personal computer, laptop, tablet or mobile device. A single application, such as client's software, and a server work together to create a target, which may include an image, video or a combination of both, for use with AR applications. The resulting target image should have improved quality and reduced turn-around time.

At 210, the user, such as a graphic artist or designer, provides an AR target 100 to the client's software. The AR target 100 may start from a photograph, a video, computer generated art, digitally created art or a combination of a photograph, video and/or generated art. The user may check the original AR target quality by requesting feedback (not shown) from the server. At 220, the user uses the client's software to modify the AR target 100 in an attempt to improve the AR characteristics of the AR target 100. For example, the user may add a pattern, random lines, unique features/objects, video, and/or an icon, which may improve the AR target 100. At 230, the client's software sends a feedback request message to the server. This request may be triggered by, but not limited to, the user, a timer, an event, a custom trigger based on an algorithm, or a custom trigger set by the user. The feedback request message includes the AR target 100 and requests feedback about the AR target 100. The feedback is then received from the server, which may include a rating and a plurality of feature points.

In some embodiments, the rating may include the results of a threshold test. In other embodiments, the rating may include a value resulting from a quantization test. A threshold test returns a Boolean flag to indicate whether the AR target 100 qualifies as a good AR image. For example, a positive indication is returned if the received AR target 100 is suitable or desirable as a final AR target. If the AR target 100 is not suitable as a final AR target, the threshold test returns a negative indication. On the other hand, the quantization test returns more information about the AR target. The quantization test returns a rating indicating at least three levels of gradation of the AR target 100 (e.g., poor, good, excellent).

In some embodiments, a plurality of feature points of the AR target 100 is fed back to the client's software. In these embodiments, the server determines a plurality of feature points from the current AR target 100, and then provides their various locations as feedback. Some embodiment return all detected feature points while other embodiment return the first N feature points (e.g., N=50, 100 or 500).

At 240, the client's software displays the rating and/or the plurality of feature points over a display target. The display target may be the same as the AR target 100. Alternatively, the display target may be an altered version of the AR target 100 such as a version with reduced information. For example, the AR target 100 may be a color target and the display target may be a gray scale or black and white version of the AR target 100. In this manner, the client's software may highlight the plurality of feature points by overlaying the plurality of feature points on top of a target with reduced information. The client's software may display the rating of the AR image as an overlay or to a side of the displayed target.

At 250, the user saves the AR target 100 to memory for use by an AR application. By saving a single or final image, a user may avoid cluttering his hard drive memory with several versions.

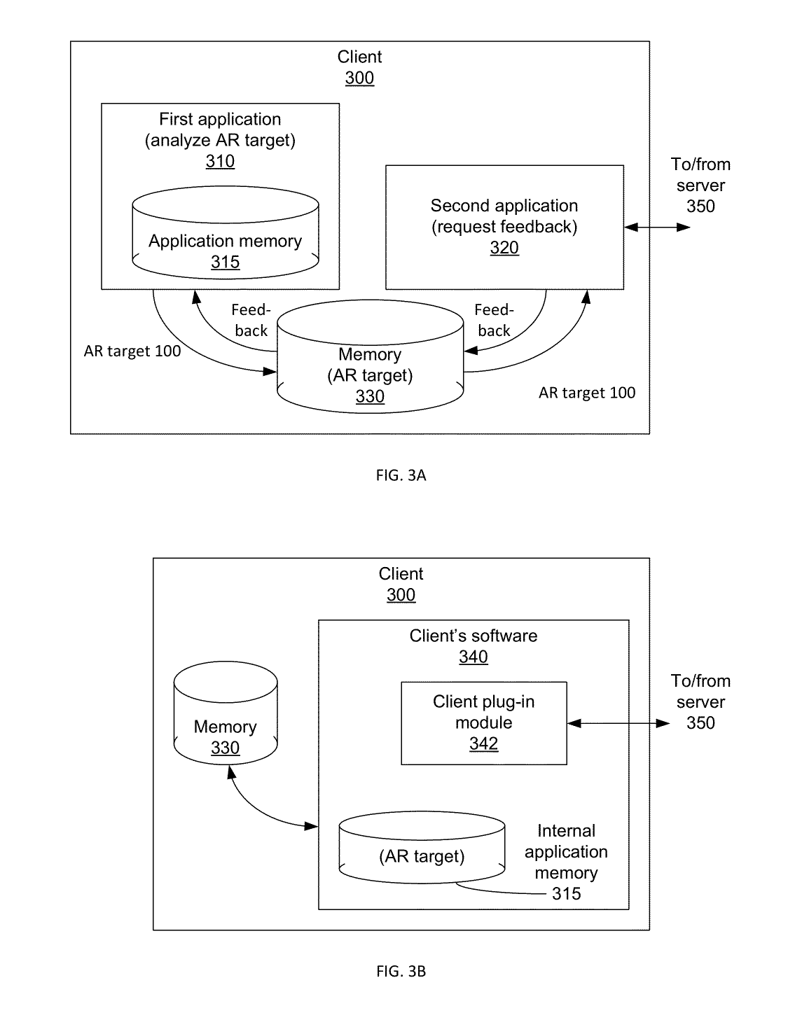

FIG. 3A shows a client 300 having a first application 310 for editing AR targets and a second application 320 for requesting feedback from a server 350. In one embodiment, a user creates and modifies an AR target 100 using the first application 310. The first application 310 uses application memory 315 that may not directly accessible by the user. The user then saves the AR target 100 to memory 330 as an interim image and external from the first application 310. The user then uses the second application 320 to load from memory 330 and send the AR target 100 to the remote server 350. A response or feedback is received from the server 350. Using the second application 320, the user receives the feedback from the server 350 and saves the feedback to memory 330. Using the first application 310, the user loads and displays the feedback from memory 330 to a display. This process may be iterative across several versions of the AR target.

FIG. 3B shows a client 300 running client's software 340, in accordance with some embodiments of the present invention. The client's software 340 includes a user plug-in module 342. Unlike in the previous method, a user may skip steps of saving an interim image and using a second application 320. In this embodiment, the user creates and edits an AR target image 100 using client's software 340. The client's software 340 uses its internal application memory 315 to hold working versions of the AR target 100. The client's software 340 displays the current working version of the AR target 100 to the user. The client's software 340 also displays the feedback from the server 350, for example: (1) as a result of a user keystroke; (2) periodically; and/or (3) as a result of a user change to the AR target 100. The client's software 340 obtains the feedback from the server 350 via a client plug-in module 342 or the like. When a user is satisfied with the AR target 100 and feedback from the server 350, the user may save the AR target 100 to memory 330. As a result, the user saves a single version or far fewer versions of the AR target 100 to memory 330.

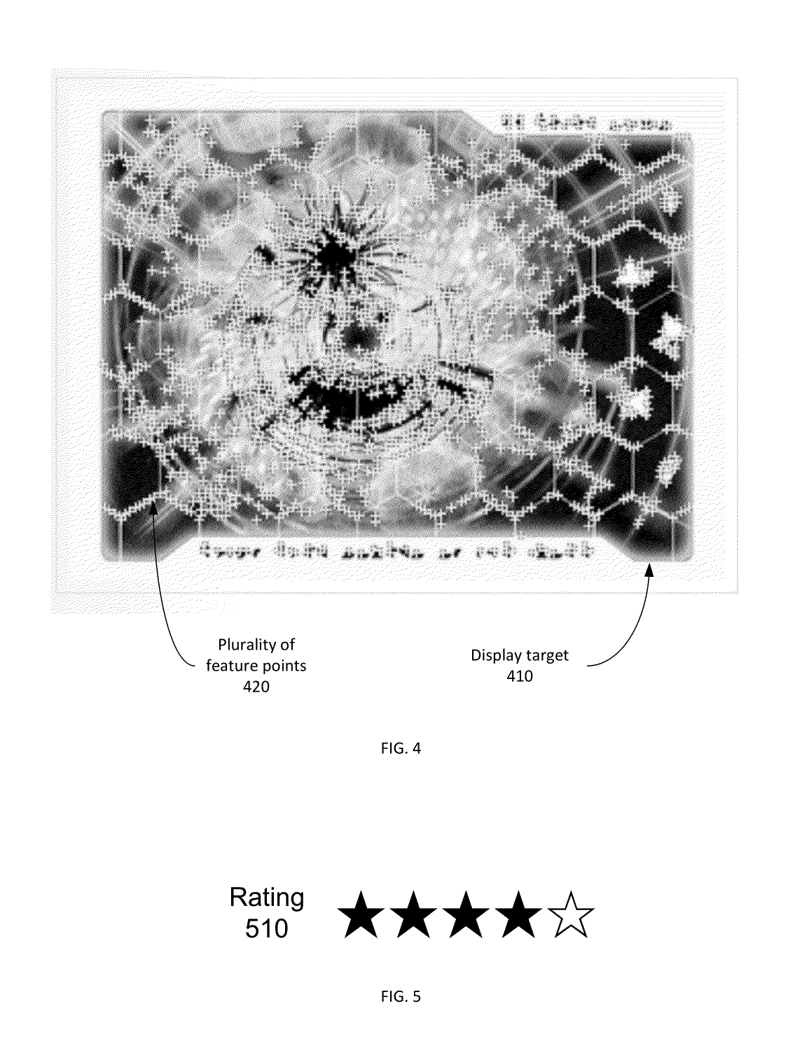

FIG. 4 shows a display target 410 including a plurality of feature points 420, in accordance with some embodiments of the present invention. In this embodiment, the feedback includes a plurality of feature points 420 overlaid on a display target 410. The display target 410 highlights to the user the plurality of feature points 420 (shown as plus marks).

FIG. 5 shows an example of a rating system. The feedback may also include a rating 510. In this embodiment, four out of five stars are shown indicating the AR target 100 is of a good quality. As previously described, the quantization test returns a rating 510 indicating multiple levels of gradation of the AR target 100. For example, a returned value may indicate a poor, good or excellent characteristic of the AR target 100 as a final AR target. In other embodiments, the rating feedback provides a number, such as a number of stars, to indicate a quality of the AR target. For example, in a five star system, a number of stars may be used to indicate the AR target 100 is very poor (one star), poor (two stars), adequate (three stars), good (four stars) or very good (five stars) as a candidate as a final AR target. Alternatively, a quantization test may return a number (e.g., 1 to 5, 1 to 10, or 1 to 100), which would indicate, for example, with a low number that the AR target 100 is poor or with a high number that the AR target 100 is excellent.

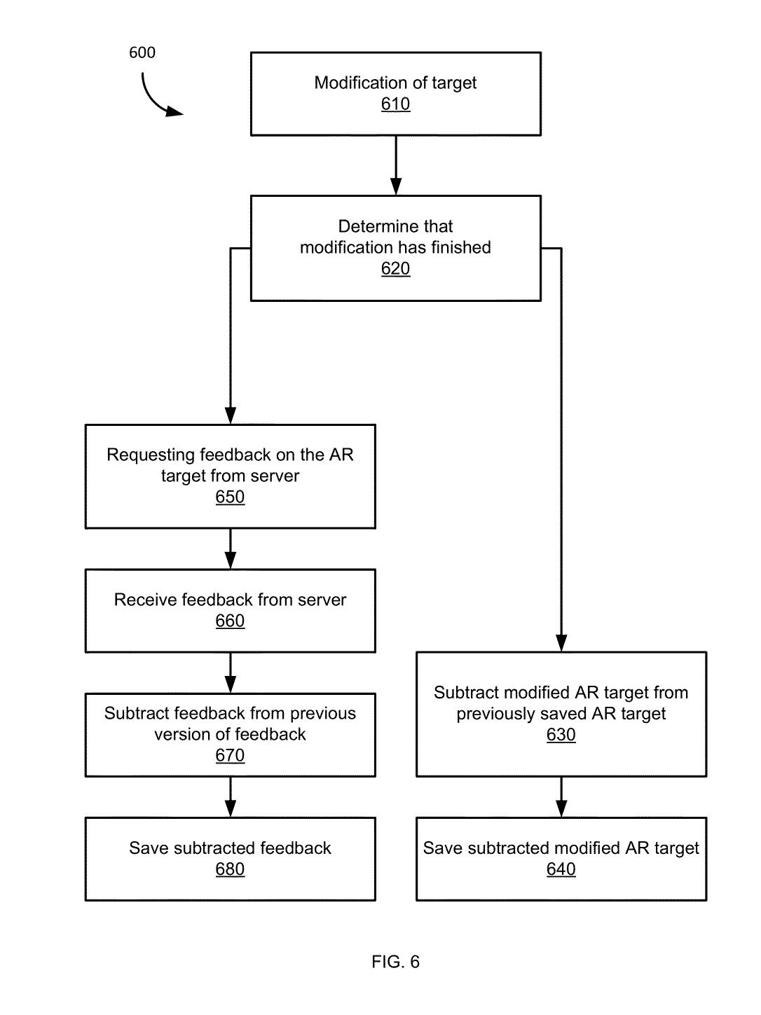

FIG. 6 shows a flow chart 600 in accordance with some embodiments of the present invention. In this embodiment, at 610, the AR target is modified 100. At 620, the client's software determines that the AR target 100 modification has finished. The client's software may make this determination via, for example, the user, timers, event based triggers, custom triggers based on algorithms, or custom triggers set by the user.

At 630, the client's software determines if there was a previous version of the AR target 100. If there was not a previous version, then the client's software saves the AR target 100 and the feedback as new versions. If there was a previous version, then the client's software subtracts or takes a difference of the previously saved AR target 100 from the currently modified AR target thereby saving space. Alternatively, the client's software saves the AR target 100 and the feedback as new versions over the old version.

At 640, the client's software saves the revised AR target. This can be done, for example, by saving the revised AR target as a layer in the same file or as a separate file.

At 650, the client's software requests feedback on the AR target 100 from the server. This can be done by sending the entire AR target 100 or the revised AR target. Sending the revised AR target allows the server to retain a copy of the AR target 100, minimizes the amount of data being sent to the server, and increases the speed by which the user receives feedback on the AR target 100.

At 660, feedback is received from the server. This feedback may include an AR target, feature points, rating of the AR target, or any combination thereof.

At 670, the client's software determines if there was previous feedback. If there is no previous feedback, then the client's software saves the feedback. If there is previous feedback, then the client's software subtracts the feature points in the current feedback from the previous feedback.

At 680, the client's software saves the subtracted feedback. This can be done by saving the subtracted feedback as a layer in the same file or as a separate file.

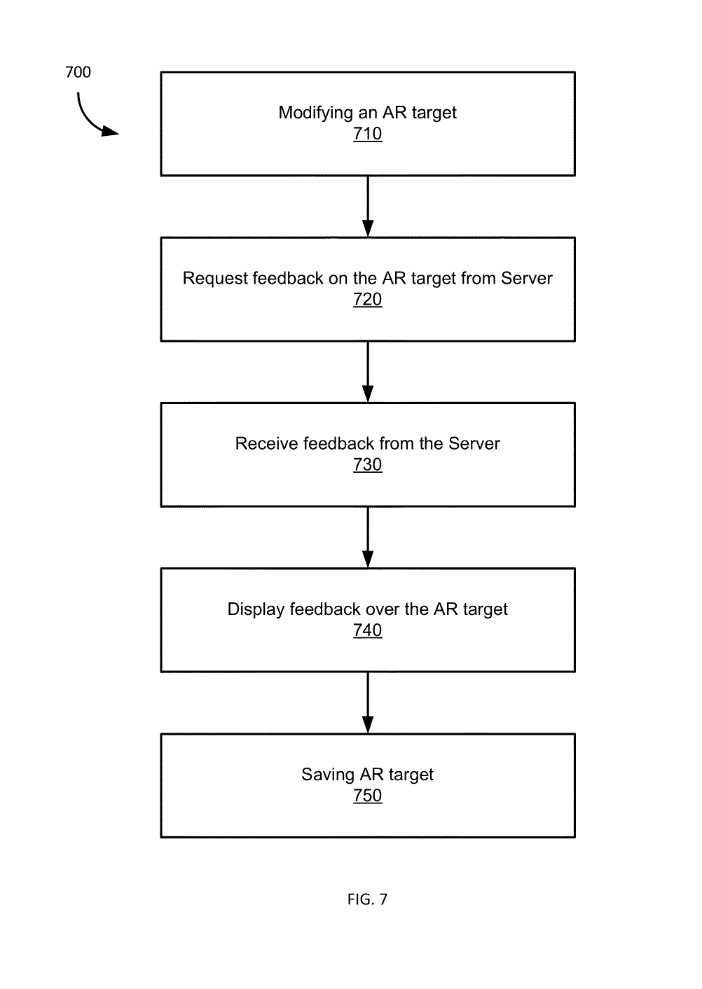

FIG. 7 illustrates a flow chart 700 for improving augmented reality (AR) targets. In this embodiment, at 710, a user modifies an AR target 100 (e.g., using client's software 340). The user may load an AR target 100 or modify an existing loaded image. At 720, the user or client's software triggers a request for feedback on the AR target 100. A request message may be triggered, for example: (1) as a result of a user keystroke; (2) periodically; and/or (3) as a result of a user change to the AR target 100. A request message is sent from the client's software 340 (e.g., from a plug-in 342) to a server with the (modified) AR target 100. The request message includes the (modified) AR target 100. The server receives and processes the request message containing the (modified) AR target 100. In response to the request message, the server produces and sends the feedback information that may include the rating and/or the plurality of feature points.

At 730, the client's software receives the feedback from the server, (e.g., via the plug-in module 342). At 740, the client's software 340 optionally displays the feedback over the AR target 100. The AR target 100 may be displayed as a display target to highlight the feedback. The user may then repeat step 710 through step 740 to improve the AR target 100. Once satisfied, at 750, the user uses the client's software to save the AR target 100 to memory. The AR target 100 is then ready to use by an AR application.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method in a client device for improving augmented reality (AR) targets, the method comprising:
modifying an AR target with a client's software;
sending a request for feedback on the AR target to a server;
receiving feedback from the server; and
saving, by the client's software, the AR target to memory.

2. The method of claim 1, further comprising:
displaying, by the client's software, the feedback over the AR target.

3. The method of claim 1, wherein the client's software comprises photo editing software.

4. The method of claim 1, wherein the client's software comprises video visual effects software.

5. The method of claim 1, wherein the feedback comprises a rating.

6. The method of claim 5, wherein the rating comprises an indication indicating whether a threshold test is passed.

7. The method of claim 5, wherein the rating comprises multiple levels of gradation.

8. The method of claim 5, wherein the feedback further comprises a plurality of feature points.

9. The method of claim 2, wherein displaying, by the client's software, the feedback over the AR target comprises displaying a plurality of feature points over the AR target with a rating.

10. The method of claim 1, wherein:
sending comprises sending from a user plug-in module in the client's software; and
receiving comprises receiving at the user plug-in module in the client's software.

11. The method of claim 1, wherein the client device comprises a personal computer (PC).

12. The method of claim 1, wherein the client device comprises a mobile device.

13. The method of claim 1, further comprising using the AR target as a target in an augmented reality (AR) application.

14. A method in a client device for saving modified augmented reality (AR) targets, the method comprising:
subtracting a previous version AR target from a current version AR target to generate a revised AR target;
sending a request for feedback on the current version AR target including sending the revised AR target to a server; and
receiving feedback from the server.

15. The method of claim 14, further comprising:
saving, by the client's software, the current version AR target to memory.

16. The method of claim 14, further comprising:
displaying, by the client's software, the feedback over the current version AR target.

17. A client device for improving augmented reality (AR) images, the client device comprising:
a memory; and
a processor coupled to the memory, the processor configured to:
modify an AR target;
send a request for feedback on the AR target to a server;
receive feedback from the server; and
save the AR target to memory.

18. The client device of claim 17, wherein the processor is configured to display the feedback over the AR target.

19. The client device of claim 17, wherein the client's software comprises photo editing software.

20. The client device of claim 17, wherein the client's software comprises video visual effects software.

21. The client device of claim 17, wherein the feedback comprises a rating.

22. The client device of claim 21, wherein the rating comprises an indication indicating whether a threshold test is passed.

23. The client device of claim 21, wherein the rating comprises multiple levels of gradation.

24. The client device of claim 21, wherein the feedback further comprises a plurality of feature points.

25. The client device of claim 18, wherein the processor is configured to display a plurality of feature points over the AR target with a rating.

26. The client device of claim 17, wherein the processor is configured to:
send the request for feedback from a user plug-in module in the client's software; and,
receive the feedback at the user plug-in module in the client's software.

27. The client device of claim 17, wherein the client device comprises a personal computer (PC).

28. The client device of claim 17, wherein the client device comprises a mobile device.

29. The client device of claim 17, wherein the AR target is used in an augmented reality (AR) application.

30. A client device for improving augmented reality (AR) images, the client device comprising:
means for modifying an AR target with a client's software;
means for sending a request for feedback on the AR target to a server;
means for receiving feedback from the server; and
means for saving the AR target to memory.

31. The client device of claim 30, further comprising means for displaying the feedback over the AR target.

32. The client device of claim 30, wherein the feedback comprises a rating.

33. The client device of claim 32, wherein the rating comprises an indication indicating whether a threshold test is passed.

34. The client device of claim 32, wherein the rating comprises multiple levels of gradation.

35. The client device of claim 32, wherein the feedback comprises a plurality of feature points.

36. The client device of claim 31, wherein means for displaying the feedback over the AR target comprises means for displaying a plurality of feature points over the AR target with a rating.

37. The client device of claim 30, wherein:
means for sending comprises means for sending from a user plug-in module in the client's software; and
means for receiving comprises means for receiving at the user plug-in module in the client's software.

38. The client device of claim 30, further comprising means for using the AR target as a target in an augmented reality (AR) application.

39. A non-transitory computer-readable storage medium including program code stored thereon, comprising program code for:
modifying an AR target with a client's software;
sending a request for feedback on the AR target to a server;
receiving feedback from the server; and
saving, by the client's software, the AR target to memory.

40. The non-transitory computer-readable storage medium of claim 39, further comprising program code for:
displaying the feedback over the AR target.

41. The non-transitory computer-readable storage medium of claim 39, wherein the client's software comprises photo editing software.

42. The non-transitory computer-readable storage medium of claim 39, wherein the client's software comprises video visual effects software.

43. The non-transitory computer-readable storage medium of claim 39, wherein the feedback comprises a rating.

44. The non-transitory computer-readable storage medium of claim 43, wherein the feedback further comprises a plurality of feature points.
